(19) United States
(12) Patent Application Publication
(10) Pub. No.: US 2026/0314583 A1
(43) Pub. Date: Oct. 15, 2026

(54) SYSTEM, METHOD, AND COMPUTER PROGRAM PRODUCT FOR IMPROVED TERMITE DETECTION

(71) Applicant: AGRINT SENSING SOLUTIONS LTD, Hod Hasharon (IL)

(72) Inventors: Yehonatan BEN HAMOZEG, Rosh Haayin (IL); Yossef SIMONI, Hertzeliya (IL)

(21) Appl. No.: 19/485,420

(22) PCT Filed: May 8, 2024
(86) PCT No.: PCT/IL2024/050439

§ 371 Date: Nov. 18, 2025

Related U.S. Application Data
(60) Provisional application No. 63/503,055, filed on May 18, 2023.

(51) Int. Cl. A01M 1/02; G01N 29/04

(52) U.S. Cl. CPC A01M 1/026; G01N 29/04

(57) ABSTRACT

System for controlling burrowing insects including a server to communicate with seismic sensors at respective location/s within the premises. Each sensor enables vibrations of an insect-consumable substance, into which the sensor is driven, to be sensed, yielding sensor output data. A communication unit communicates, from the sensor to the remote server, i. sensor output data and/or ii. an identifier unique to the individual sensor; and/or iii. a time-stamp identifying a time-point at which the data was sensed by the sensor/s. The server differentiates, for point/s in time, an insect-consumable substance in which insects are/aren't present, and stores information associating identifiers of certain sensors, with data indicating whether burrowing insects are present in the insect-consumable substance into which each sensor is/are respectively driven, at given stored time-points corresponding to the time-stamp/s.

### FIELD OF THIS DISCLOSURE

The present invention relates generally to detection of burrowing insects, and more particularly to indoor termite detection.

### BACKGROUND FOR THIS DISCLOSURE

Detecting burrowing insects, and specifically weevils, is known e.g., as described in the following co-owned patent document: https://patents.google.com/patent/US11324210B2.

Termites are a type of burrowing insect which inflict structural damage on wood structures, thus termite control and damage is a huge problem; for example repair costs in Indonesia alone are estimated at over IDR 8.7 trillion per year; and termites are said to cause billions of dollars of property damage in the United States annually—the resulting property damage being only rarely covered by homeowners insurance.

Termites wreak havoc, including on insulation in walls and in books on shelves. Termite infestation, if untreated, can fell an entire house. Moreover, the chemicals used to control termites are hazardous for persons suffering from asthma or allergies.

It is known that termite control costs can be substantially reduced when infestations are detected earlier. Early detection is thus critical, with environmental regulations regarding termiticides becoming more stringent.

Visual inspection by a human inspector is known and requires training; other impediments include inaccessibility of buildings. Other methods of termite-detecting are configured to detect temperature, acoustic content, moisture content, or gas.

Known academic articles on termite detection include:
https://www.eurasip.org/Proceedings/Eusipco/Eusipco2008/papers/1569095383.pdf
https://link.springer.com/article/10.1007/s00107-023-01948-1
https:/www.researchgate.net/publication/303544453_Signal_discrimination_via_non-Gaussian _modeling_with_application_to_termite_detection
https:/nature.berkeley.edu/upmc/documents/Sensor%20Performance%20in%20Acoustically% 20Detecting%20Drywood%20Termites.pdf
https:/www.researchgate.net/publication/334982512_Development_of_termite_detection_system based_on_acoustic_and_temperature_signals
https://www.sciencedirect.com/science/article/abs/pii/S0263224106001977
https://www.pestboard.ca.gov/howdoi/research/ucbfinal.pdf
https://www.sciencedirect.com/science/article/abs/pii/S0263224106001977.

Detecting a possible infestation in a noisy measurement scenario, including use of a seismic-waves sensor is described; it is included “that it is possible to establish a higher-order pattern associated to the termite emissions, and resulting from the impulsive response of the sensor and the body or substratum through which the emitted waves propagate” (see e.g.
https://www.sciencedirect.com/science/article/abs/pii/S0263224106001977).

This source https://www.sciencedirect.com/science/article/abs/pii/S0888327007001562 mentions non-destructive termite detection in non-favorable SNR scenarios via signal processing using higher-order statistics.

However, some impartial experts found, in approximately 2009, when it is not clear that breakthroughs have occurred even thereafter, that they “cannot recommend a single detection device that can . . . demonstrate that termites are active in walls . . . . The best option for drywood termite, or any other wood destroying insect, is inspection by a trained operator with 20 years of field experience and permission to open walls for further inspection. The next best option would be after identifying a wall, or better yet a single board, use an AE device with a subsurface sensor (small wood screw sensor) to determine the board is active for drywood termites. A second device, this time a portable microwave sensor, can be passed held against the board or even drywall (be careful not to hold the device, best to use a tripod to minimize false positives due to vibrations) to aid in identifying the exact locations of galleries. This detection strategy works best for local treatment, where the exact knowledge of active boards and gallery architecture is critical to success.” (see e.g. https://www.pestboard.ca.gov/howdoi/research/ucbfinal.pdf)

Similarly, an impartial source published in 2008 that “Termite detection has been gaining importance . . . due to the urgent necessity of avoiding the use of harming termiticides . . . . The primary method of termite detection consists of looking for evidence of activity. But only about 25% of the building structure 1S accessible” https://www.sciencedirect.com/science/article/abs/pii/S0263224106001977

Termites' acoustic signals have good detection potential with an accuracy of approximately 80%; detectable acoustics are generated by feeding-excavating and by head-banging by workers and soldiers (see e.g. https://www.tandfonline.com/doi/full/10.1080/26895293.2023.2167866).

Termite image recognition suitable for mobile applications has been suggested e.g., here: https://academic.oup.com/jee/article/114/6/2452/6359981.

An example of conventional bait stations is described here: https://diypestcontrol.com/crawling-insects/termite-control-products/advance-termite-bait-systems

The disclosures of all publications and patent documents mentioned in the specification, and of the publications and patent documents cited therein directly or indirectly, are hereby incorporated by reference other than subject matter disclaimers or disavowals. If the incorporated material is inconsistent with the express disclosure herein, the interpretation is that the express disclosure herein describes certain embodiments, whereas the incorporated material describes other embodiments. Definition/s within the incorporated material may be regarded as one possible definition for the term/s in question.

### SUMMARY OF CERTAIN EMBODIMENTS

Certain embodiments of the present invention seek to provide circuitry typically comprising at least one processor in communication with at least one memory, with instructions stored in such memory executed by the processor to provide functionalities which are described herein in detail. Any functionality described herein may be firmware-implemented or processor-implemented, as appropriate.

Certain embodiments herein seek to improve termite detection, thereby to facilitate termite control e.g., via pesticides.

Certain embodiments include a termite detection system that monitors for termites 24/7, as opposed to relying on relatively infrequent human inspection.

Certain embodiments seek to provide a termite detector which detects insects in the wood that is present in the large population of already-deployed bait stations which are repeatedly inspected by human experts and leverages, resulting in knowledge to greatly improve existing termite control paradigms.

It is appreciated that any reference herein to, or recitation of, an operation being performed is, e.g. if the operation is performed at least partly in software, is intended to include both an embodiment where the operation is performed in its entirety by a server A, and also to include any type of “outsourcing” or “cloud” embodiments in which the operation, or portions thereof, is or are performed by a remote processor P (or several such), which may be deployed off-shore or “on a cloud”, and an output of the operation is then communicated to, e.g. over a suitable computer network, and used by, server A. Analogously, the remote processor P may not, itself, perform all of the operations, and, instead, the remote processor P itself may receive output/s of portion/s of the operation from yet another processor/s P′, may be deployed off-shore relative to P, or “on a cloud”, and so forth.

The present invention typically includes at least the following embodiments:

Embodiment 1. A system for controlling burrowing insects, the system comprising:
a remote server typically configured to communicate with plural sets of seismic sensors respectively deployed at plural premises, each set at a given premises typically including seismic sensor/s deployed at respective location/s within the given premises; wherein each seismic sensor typically enables vibrations of an insect-consumable substance, into which the seismic sensor is driven, to be sensed, thereby to yield sensor output data, and/or a communication unit which communicates, from the sensor to the remote server, all or any subset of: i. the sensor output data, an identifier unique to the individual seismic sensor; and iii. a time-stamp identifying a point in time at which the sensor output data was sensed by the seismic sensor, thereby to define time-stamp/s; and wherein the remote server is typically configured to differentiate, for at least one point in time, an insect-consumable substance in which burrowing insects are present from an insect-consumable substance in which no burrowing insects are present, and/or to store information associating identifiers certain seismic sensors, with data indicating whether burrowing insects are present in the insect-consumable substance into which each of the certain seismic sensors are respectively driven, at given stored points in time corresponding to the time-stamp/s. The sensor may comprise any suitable vibration detector, such as but not limited to a seismic detector. It is appreciated that commercially available and/or known vibration detectors include “seismic” detectors which detect vibrations of a solid e.g., the ground or in wood as well as “acoustic” detectors which detect vibration of the air.

Embodiment 2. The system according to any of the preceding embodiments wherein the seismic sensors comprise baiting stations which include bait, enabling insects to burrow in or consume the bait, and wherein the insect-consumable substance comprises the bait. The bait is typically attractive to insects and is typically accessible to insects.

Embodiment 3. The system according to any of the preceding embodiments and also comprising baiting stations which include bait accessible to insects, enabling insects to burrow in or consume the bait, and wherein the seismic sensors comprise the baiting stations and the insect-consumable substance comprises the bait.

Embodiment 4. The system according to any of the preceding embodiments and also comprising seismic sensors configured to be driven into a household object which functions as the insect-consumable substance.

Embodiment 5. The system according to any of the preceding embodiments wherein the seismic sensors are configured to be driven into a household object which functions as the insect-consumable substance. The household object, which is typically wooden, may for example comprise a wall, floor or deck, ceiling, stairs, frame or sill e.g. of a door or window, pillar/post, or banister, article of furniture or storage unit (closet or shelf e.g.), ornament, or recreational object such as a gaming table or musical instrument or toy.

Embodiment 6. A method for controlling burrowing insects, the method comprising: providing a remote server configured to communicate with plural sets of seismic sensors respectively deployed at plural premises, each set at a given premises including seismic sensor/s deployed at respective location/s within the given premises, wherein seismic sensors enable vibrations of an insect-consumable substance, into which the seismic sensor is driven, to be sensed, thereby to yield sensor output data, and/or providing a communication unit which communicates, from the sensor to the remote server, all or any subset of: i. the sensor output data, ii. an identifier unique to the individual seismic sensor; and iii. a time-stamp identifying a point in time at which the sensor output data was sensed by the seismic sensor, thereby to define time-stamp/s; and wherein the remote server typically includes at least one hardware processor configured to differentiate, for at least one point in time, an insect-consumable substance in which burrowing insects are present from an insect-consumable substance in which no burrowing insects are present, and to store information associating identifiers of certain seismic sensors, with data indicating whether burrowing insects are present in the insect-consumable substance into which each of the certain seismic sensors are respectively driven, at given stored points in time corresponding to the time-stamp/s.

Embodiment 7. The method according to any of the preceding embodiments wherein the plural sets of seismic sensors are respectively deployed within plural sets of bait stations respectively deployed at the plural premises, and wherein the server is trained to differentiate substances in which burrowing insects are present from substances in which burrowing insects are absent, using outcomes of human inspections of the plural sets of bait stations as tags, which, when coupled with outputs from seismic sensors, serve as training data, thereby to yield a detection algorithm for at least one species of burrowing insect.

Embodiment 8. The method according to any of the preceding embodiments wherein the outcomes of human inspections include indications of which species of burrowing insect were present and wherein the server is trained to differentiate substances in which burrowing insects of a first species are present from substances in which burrowing insects of the first species are absent using outcomes of human inspections of the plural sets of bait stations, which indicate whether the first species was present or absent, as tags, thereby to yield a first detection algorithm for the first species of burrowing insect.

Embodiment 9. The method according to any of the preceding embodiments wherein the server is also trained to differentiate substances in which burrowing insects of a second species are present from substances in which burrowing insects of the second species are absent using outcomes of human inspections of the plural sets of bait stations, which indicate whether the second species was present or absent, as tags, thereby to yield a second detection algorithm for the second species of burrowing insect.

Embodiment 10. The method according to any of the preceding embodiments wherein the detection algorithm is applied to sensor data collected by seismic sensors deployed indoors thereby to provide improved indoor detection by leveraging human inspections of bait stations deployed outdoors.

Embodiment 11. The method according to any of the preceding embodiments wherein the first and second detection algorithms are each applied to sensor data collected by seismic sensors deployed indoors to provide improved indoor detection of insects belonging to the first and second species by using separately optimized algorithms for various species, rather than a single general insect presence detection algorithm, by leveraging species-specific human inspections of bait stations deployed outdoors.

Embodiment 12. The system according to any of the preceding embodiments and wherein the communication unit communicates, from the sensor to the remote server, all of:
i. the sensor output data,
ii. the identifier unique to the individual seismic sensor; and
iii. the time-stamp identifying the point in time at which the sensor output data was sensed.

Embodiment 13. The system according to any of the preceding embodiments wherein the insect-consumable substance comprises a termite-consumable substance such as wood, and wherein the remote server is configured to differentiate, for at least one point in time, a termite-consumable substance in which termites are present from a termite-consumable substance in which no termites are present, and to store information associating identifiers of certain seismic sensors, with data indicating whether termites are present in the termite-consumable substance into which each of the certain seismic sensors' respective seismic sensors are respectively driven, at given stored points in time corresponding to the time-stamp/s.

Embodiment 14. A computer program product, comprising a non-transitory tangible computer readable medium having computer readable program code embodied therein, the computer readable program code adapted to be executed to implement a method for controlling burrowing insects, the method comprising: providing a remote server configured to communicate with plural sets of seismic sensors respectively deployed at plural premises, each set at a given premises including seismic sensor/s deployed at respective location/s within the given premises, wherein seismic sensors enable vibrations of an insect-consumable substance, into which the seismic sensor is driven, to be sensed, thereby to yield sensor output data, and providing a communication unit which communicates, from the sensor to the remote server, all or any subset of: i. the sensor output data, ii. an identifier unique to the individual seismic sensor; and iii. a time-stamp identifying a point in time at which the sensor output data was sensed by the seismic sensor, thereby to define time-stamp/s; and wherein the remote server includes at least one hardware processor configured to differentiate, for at least one point in time, an insect-consumable substance in which burrowing insects are present from an insect-consumable substance in which no burrowing insects are present, and to store information associating identifiers of certain seismic sensors, with data indicating whether burrowing insects are present in the insect-consumable substance into which each of the certain seismic sensors are respectively driven, at given stored points in time corresponding to the time-stamp/s.

Also provided, excluding signals, is a computer program comprising computer program code means for performing any of the methods shown and described herein when the program is run on at least one computer; and a computer program product, comprising a typically non-transitory computer-usable or -readable medium e.g. non-transitory computer-usable or -readable storage medium, typically tangible, having a computer readable program code embodied therein, the computer readable program code adapted to be executed to implement any or all of the methods shown and described herein. The operations in accordance with the teachings herein may be performed by at least one computer specially constructed for the desired purposes, or a general purpose computer specially configured for the desired purpose by at least one computer program stored in a typically non-transitory computer readable storage medium. The term “non-transitory” is used herein to exclude transitory, propagating signals or waves, but to otherwise include any volatile or non-volatile computer memory technology suitable to the application.

Any suitable processor/s, display and input means may be used to process, display e.g. on a computer screen or other computer output device, store, and accept information such as information used by or generated by any of the methods and apparatus shown and described herein; the above processor/s, display and input means including computer programs, in accordance with all or any subset of the embodiments of the present invention. Any or all functionalities of the invention shown and described herein, such as but not limited to operations within flowcharts, may be performed by any one or more of: at least one conventional personal computer processor, workstation, or other programmable device or computer or electronic computing device or processor, either general-purpose or specifically constructed, used for processing; a computer display screen and/or printer and/or speaker for displaying; machine-readable memory such as flash drives, optical disks, CDROMs, DVDs, BluRays, magnetic-optical discs or other discs; RAMs, ROMs, EPROMs, EEPROMs, magnetic or optical or other cards, for storing, and keyboard or mouse for accepting. Modules illustrated and described herein may include any one or combination or plurality of: a server, a data processor, a memory/computer storage, a communication interface (wireless (e.g., BLE) or wired (e.g., USB)), a computer program stored in memory/computer storage.

The term “process” as used above is intended to include any type of computation or manipulation or transformation of data represented as physical, e.g., electronic, phenomena which may occur or reside e.g., within registers and/or memories of at least one computer or processor. Use of nouns in singular form is not intended to be limiting; thus, the term processor is intended to include a plurality of processing units which may be distributed or remote, the term server is intended to include plural typically interconnected modules running on plural respective servers, and so forth.

The above devices may communicate via any conventional wired or wireless digital communication means, e.g., via a wired or cellular telephone network, or a computer network such as the Internet.

The apparatus of the present invention may include, according to certain embodiments of the invention, machine readable memory containing or otherwise storing a program of instructions which, when executed by the machine, implements all or any subset of the apparatus, methods, features, and functionalities of the invention shown and described herein. Alternatively, or in addition, the apparatus of the present invention may include, according to certain embodiments of the invention, a program as above, which may be written in any conventional programming language, and optionally a machine for executing the program, such as but not limited to a general-purpose computer, which may optionally be configured or activated in accordance with the teachings of the present invention. Any of the teachings incorporated herein may, wherever suitable, operate on signals representative of physical objects or substances.

The embodiments referred to above, and other embodiments, are described in detail in the next section.

Any trademark occurring in the text or drawings is the property of its owner, and occurs herein merely to explain or illustrate one example of how an embodiment of the invention may be implemented.

Unless stated otherwise, terms such as, “processing”, “computing”, “estimating”, “selecting”, “ranking”, “grading”, “calculating”, “determining”, “generating”, “reassessing”, “classifying”, “generating”, “producing”, “stereo-matching”, “registering”, “detecting”, “associating”, “superimposing”, “obtaining”, “providing”, “accessing”, “setting” or the like, refer to the action and/or processes of at least one computer/s or computing system/s, or processor/s or similar electronic computing device/s or circuitry, that manipulate and/or transform data which may be represented as physical, such as electronic, quantities e.g. within the computing system's registers and/or memories, and/or may be provided on-the-fly, into other data which may be similarly represented as physical quantities within the computing system's memories, registers or other such information storage, transmission or display devices, or may be provided to external factors e.g. via a suitable data network. The term “computer” should be broadly construed to cover any kind of electronic device with data processing capabilities, including, by way of non-limiting example, personal computers, servers, embedded cores, computing systems, communication devices, processors (e.g. digital signal processor (DSP), microcontrollers, field programmable gate array (FPGA), application specific integrated circuit (ASIC), etc.) and other electronic computing devices. Any reference to a computer, controller, or processor is intended to include one or more hardware devices e.g., chips, which may be co-located, or remote from one another. Any controller or processor may for example comprise at least one CPU, DSP, FPGA, or ASIC, suitably configured in accordance with the logic and functionalities described herein.

Any feature or logic or functionality described herein may be implemented by processor/s or controller/s configured as per the described feature or logic or functionality, even if the processor/s or controller/s are not specifically illustrated for simplicity. The controller or processor may be implemented in hardware, e.g., using one or more Application-Specific Integrated Circuits (ASICs) or Field-Programmable Gate Arrays (FPGAs), or may comprise a microprocessor that runs suitable software, or a combination of hardware and software elements.

The present invention may be described, merely for clarity, in terms of terminology specific to, or references to, particular programming languages, operating systems, browsers, system versions, individual products, protocols, and the like. It will be appreciated that this terminology or such reference/s is intended to convey general principles of operation clearly and briefly, by way of example, and is not intended to limit the scope of the invention solely to a particular programming language, operating system, browser, system version, or individual product or protocol. Nonetheless, the disclosure of the standard or other professional literature defining the programming language, operating system, browser, system version, or individual product or protocol in question, is incorporated by reference herein in its entirety.

Elements separately listed herein need not be distinct components and alternatively may be the same structure. A statement that an element or feature may exist is intended to include (a) embodiments in which the element or feature exists; (b) embodiments in which the element or feature does not exist; and (c) embodiments in which the element or feature exist selectably, e.g., a user may configure or select whether the element or feature does or does not exist.

Any suitable input device, such as but not limited to a sensor, may be used to generate or otherwise provide information received by the apparatus and methods shown and described herein. Any suitable output device or display may be used to display or output information generated by the apparatus and methods shown and described herein. Any suitable processor/s may be employed to compute or generate or route, or otherwise manipulate or process information as described herein and/or to perform functionalities described herein and/or to implement any engine, interface, or other system illustrated or described herein. Any suitable computerized data storage e.g., computer memory, may be used to store information received by or generated by the systems shown and described herein. Functionalities shown and described herein may be divided between a server computer and a plurality of client computers. These or any other computerized components shown and described herein may communicate between themselves via a suitable computer network.

The system shown and described herein may include user interface/s e.g. as described herein which may, for example, include all or any subset of: an interactive voice response interface, automated response tool, speech-to-text transcription system, automated digital or electronic interface having interactive visual components, web portal, visual interface loaded as web page/s or screen/s from server/s via communication network/s to a web browser or other application downloaded onto a user's device, automated speech-to-text conversion tool, including a front-end interface portion thereof, and back-end logic interacting therewith. Thus, the term user interface, or “UI” as used herein, includes also the underlying logic which controls the data presented to the user e.g., by the system display, and receives and processes and/or provides to other modules herein, data entered by a user e.g. using her or his workstation/device.

### BRIEF DESCRIPTION OF THE DRAWINGS

Example embodiments are illustrated in the various drawings. Specifically:

FIGS. 1-3 , and 8 are pictorial illustrations of systems for detection of burrowing insects according to embodiments of the invention.

FIGS. 4 and 5 are schematic and cross-sectional views of sensors in accordance with embodiments of the invention.

FIGS. 6-7 are exploded views of a conductive component according to certain embodiments.

All or any subset of the illustrated elements may be provided, in any suitable arrangement e.g., as shown.

In the block diagrams, arrows between modules may be implemented as APIs and any suitable technology may be used for interconnecting functional components or modules illustrated herein in a suitable sequence or order e.g., via a suitable API/Interface. For example, state of the art tools may be employed, such as but not limited to Apache Thrift and Avro which provide remote call support. Or, a standard communication protocol may be employed, such as but not limited to HTTP or MQTT, and may be combined with a standard data format, such as but not limited to JSON or XML. According to one embodiment, one of the modules may share a secure API with another. Communication between modules may comply with any customized protocol or customized query language, or may comply with any conventional query language or protocol.

Methods and systems included in the scope of the present invention may include any subset or all of the functional blocks shown in the specifically illustrated implementations by way of example, in any suitable order e.g., as shown. Flows may include all or any subset of the illustrated operations, suitably ordered e.g., as shown. Tables herein may include all or any subset of the fields and/or records and/or cells and/or rows and/or columns described.

Computational, functional, or logical components described and illustrated herein, can be implemented in various forms, for example, as hardware circuits, such as but not limited to custom VLSI circuits or gate arrays or programmable hardware devices, such as but not limited to FPGAs, or as software program code stored on at least one tangible or intangible computer readable medium and executable by at least one processor, or any suitable combination thereof. A specific functional component may be formed by one particular sequence of software code, or by a plurality of such, which collectively act or behave or act as described herein with reference to the functional component in question. For example, the component may be distributed over several code sequences such as but not limited to objects, procedures, functions, routines, and programs and may originate from several computer files which typically operate synergistically.

Each functionality or method herein may be implemented in software (e.g., for execution on suitable processing hardware such as a microprocessor or digital signal processor), firmware, hardware (using any conventional hardware technology such as Integrated Circuit technology), or any combination thereof.

Functionality or operations stipulated as being software-implemented may alternatively be wholly or fully implemented by an equivalent hardware or firmware module, and vice-versa. Firmware implementing functionality described herein, if provided, may be held in any suitable memory device, and a suitable processing unit (aka processor) may be configured for executing firmware code. Alternatively, certain embodiments described herein may be implemented partly or exclusively in hardware, in which case all or any subset of the variables, parameters, and computations described herein may be in hardware.

Any module or functionality described herein may comprise a suitably configured hardware component or circuitry. Alternatively, or in addition, modules or functionality described herein may be performed by a general purpose computer or more generally by a suitable microprocessor, configured in accordance with methods shown and described herein, or any suitable subset, in any suitable order, of the operations included in such methods, or in accordance with methods known in the art.

Any logical functionality described herein may be implemented as a real time application, if and as appropriate, and which may employ any suitable architectural option, such as but not limited to FPGA, ASIC or DSP or any suitable combination thereof.

Any hardware component mentioned herein may in fact include either one or more hardware devices e.g., chips, which may be co-located or remote from one another.

Any method described herein is intended to include within the scope of the embodiments of the present invention also any software or computer program performing all or any subset of the method's operations, including a mobile application, platform or operating system e.g., as stored in a medium, as well as combining the computer program with a hardware device to perform all or any subset of the operations of the method.

Data can be stored on one or more tangible or intangible computer readable media stored at one or more different locations, different network nodes or different storage devices at a single node or location.

It is appreciated that any computer data storage technology, including any type of storage or memory and any type of computer components and recording media that retain digital data used for computing for an interval of time, and any type of information retention technology, may be used to store the various data provided and employed herein. Suitable computer data storage or information retention apparatus may include apparatus which is primary, secondary, tertiary, or off-line, which is of any type or level or amount or category of volatility, differentiation, mutability, accessibility, addressability, capacity, performance, and energy use, and which is based on any suitable technologies such as semiconductor, magnetic, optical, paper, and others.

### DETAILED DESCRIPTION OF CERTAIN EMBODIMENTS

While insect infestations are always unpleasant for those persons affected, infestations of burrowing insects in general, and termites in particular, are particularly desirable to avoid, since entire residence components, even structural elements of a building or house, may need to be replaced, which is extremely costly.

Subterranean termites, common in the USA, live below ground in colonies interconnected by tunnels. Subterranean termites generate tunnels through soil, until they encounter wood, which is their primary food. Termite colonies inflicting damage on a house may actually be located on a neighbor's property, rather than within the yard of the infested home.

Termite bait stations are considered state of the art, versus traditional insecticide sprays, being safer for children, pets, and wildlife, and versus a chemical barrier e.g., liquid pesticide, aka ‘termiticide,’ such as Termidor®/fipronil, imidacloprid, and chlorantraniliprole, which involve large amounts of termiticide being applied around the perimeter of the building, and which involve drilling/injection through adjacent structures such as porches or patios.

Termite bait stations, which use much smaller amounts of poison, are typically buried in the ground, a few meters apart, around a property's perimeter, with the very top of the trap sitting flush with the ground surface, so as not to cause any unsightly or inconvenient obstructions within the yard or property, and also since termites travel underground.

Termites are attracted to the baiting stations e.g., due to bait such as, say, Tasmanian Oak timber or other cellulose, which termites favor as a food source. Attractants e.g., Focus, which are believed to have the ability to draw termites in from distances of a few meters away, may be used. Pest control materials e.g., Hexaflumuron, may be placed in infested stations, and each station is typically locked with a secure cap.

Customers are typically required to sign up for a 12-month (say) contract which includes installation of the bait stations and monthly inspections. Other protocols may call for inspection of stations to occur quarterly, biannually, or annually. Installation of a termite bait system for a standard sized home, on a regular sized block, can require an entire day. Usually, the traps are set beneath the ground every 3 meters apart, strategically placed around the outer edge of the property. Sometimes, stations need to be installed directly through pavement.

Inspectors typically fill in a service form, indicating the state of infestation of every trap deployed. Some experts say that “In the second and third years, traps are usually checked every eight weeks. Continual vigilance is vital, as termite colonies are constantly moving through the ground, so it's common for a home with a termite bait system to have three or four different hits a year, from a number of different termite colonies” (see https://www.pest-ex.com.au/blog/how-do-termite-bait-stations-traps-work-are-they-safe/). Absent retention of a termite control service, infestations can go undetected for years, and cause extensive damage.

Termite baits may include a delayed action insecticide, as opposed to immediate action poison which causes sick or dead termites to accumulate near stations, which may cause other termites to avoid the trap. This eliminates entire colonies, which may not be necessary, since structural protection may be achievable without colony elimination.

The bait station housing may be a hollow receptacle e.g., plastic cylinder with apertures e.g., slits along the sides, via which termites may enter.

Certain embodiments herein stem from a realization that conventional termite detection systems are not very satisfactory. For one thing, to prevent infestation from occurring and from recurring, periodic human inspection is typically engaged. Yet, if the periodicity is high, this is very costly, and if periodicity is low, there is a concern that infestation may be detected only after foundational portions (beams or walls e.g.) of a building have been infected. Replacing these is even more costly, nor is there any systematic way to determine how often inspection should occur, to balance these opposing concerns. Furthermore, early detection often relies on the baiting stations which are deployed to encircle a building or other structure to be protected. These are costly to deploy, since they typically need to be embedded in the ground. These stations also need to be maintained e.g., because operability is limited (say to 10 years or less), and/or because batteries need to be replaced (say every 3 years). All these operations require on-site presence of technicians.

Also, if infestation is found and poison is deployed, this poison affects (inter alia, or exclusively) termites outside of the building to be protected, although these are ecologically beneficial. Finally, termites do not always discover the baiting stations such that termites may happen upon, and set upon, the structure to be protected before they happen upon the baiting stations, causing damage, often costly and difficult to fix, which is detected only once some of the termites happen upon the station (and even then, an additional interval of time elapses until periodic inspection occurs).

Early detection is also difficult because early warning signs of termites, such as a sagging or collapsing floor or porch and/or cracked paint can indicate termites or unrelated issues such as water damage or some other pest, or both. Thus, human experts are needed to determine whether or not termites are present.

The later the detection, the more difficult termite control becomes. For example, drilling many holes (e.g., every 3-4 inches) in wood floors or porches may be required to gain access to the area where infestation is suspected, to apply the poison, such as, say, Termidor. Even so, up to 90 days may be required to be rid of the termites.

Also, deployment of bait stations requires expert discretion e.g., if termites fail to discover (or consume) the bait, additional stations may need to be added and/or many gallons of liquid barrier termiticide, which is objectionable from a health and environmental standpoint, may be required to be injected into the ground around the structure and also underneath. Moreover, ongoing surveillance of the stations is often not enough; monitoring of the building itself is also required.

Moreover, termites cannot see or smell baits deployed the soil; they instead simply wander into them (or not). Whether the termites eventually find or discover the bait stations is currently a matter of luck. Also, probability of getting termites to find the bait is low when ground is frozen, snow-covered, or saturated, which impedes feeding hence bait discovery, whereas during this same period, feeding within the warmer structure may continue apace. During periods of drought, when termites forage more deeply for moisture, bait discovery may also be low, whereas feeding on the indoor walls may continue apace. Finally, since, at best, bait discovery takes time, the bait station approach requires homeowners to accept the possibility of a lengthy process.

The system according to certain embodiments herein leverages the existing deployment of human-inspected termite baiting stations, worldwide, to jump-start an effective AI-based termite control system, typically including using human inspection, to tag certain time-points in a stream of acoustic data collected from an IOT which unites the existing worldwide population of human-inspected stations, thereby to provide training data for the AI-based termite control system's server. Initially, e.g., before training, the algorithm may utilize any suitable known knowledge about termite detection e.g., as described herein, and/or in:
https://www.eurasip.org/Proceedings/Eusipco/Eusipco2008/papers/1569095383.pdf
https://link.springer.com/article/10.1007/s00107-023-01948-1
https:/www.researchgate.net/publication/303544453_Signal_discrimination_via_non-Gaussian _modeling_with_application_to_termite_detection
https:/nature.berkeley.edu/upmc/documents/Sensor%20Performance%20in%20Acoustically% 20Detecting%20Drywood%20Termites.pdf
https://www.researchgate.net/publication/334982512 Development_of_termite_detection_system _based_on_acoustic_and_temperature_signals
https://www.sciencedirect.com/science/article/abs/pii/S0263224106001977
https://www.pestboard.ca.gov/howdoi/research/ucbfinal.pdf
https://www.sciencedirect.com/science/article/abs/pii/S0263224106001977

This yields a system which typically detects insect e.g., termite infestations and/or reinfestations, cost effectively, and at an early stage. Conventional systems have baiting stations which are inspected only infrequently by human inspectors who travel specially to each of the plural premises, yielding costly, infrequent (hence late) detection, as opposed to automatic, 24/7detection.

The system also typically trains cost effectively, since the reality is that large populations of baiting systems are deployed, to detect infestation and/or re-infestation early and/or to treat same, and, currently, are manned by humans. The server typically tags the acoustic output data using yes/no infestation decisions made by human inspectors which are retained to inspect the baiting stations in any event, thereby to cost effectively provide training data. Once the system is trained, human inspection frequency may be reduced or even eliminated.

Certain embodiments include a termite detector which detects termites in baiting stations; the detector may include a structural element which is driven into bait and which conducts seismic waves; the waves are detected and communicated to a processor or server which may be remote. Once such a system's detection algorithm is verified vis a vis human inspection which occurs anyway, and/or is trained, e.g., based on machine learning which can use the human inspection reports as training data, termite detection becomes far more effective, both functionally and in terms of cost. For one thing, termite infestation is detected essentially immediately or within seconds, minutes, hours, or, at most, within days, and not weeks or months after it occurs when an inspector finally arrives at the premises. For another, inspectors travelling to disparate locations is obviated, which reduces costs .. It is somewhat counter-intuitive that this embodiment is valuable, since human presence is known to be advisable upon detection of infestation (to fumigate and to fix damage). However, in fact, comparing the human presence required according to certain embodiments, with the human presence required conventionally, it is seen that many instances of conventional human expert presence are superfluous (the human expert travels all the way to the site to be protected/, only to find that no termites are present) and those instances in which conventional human expert presence are not superfluous, because when termites are found to be present, these are, to a large extent, instances of late detection which are difficult to fumigate, and the damage that may have occurred is costly and disruptive (to those residing in the structure) to fix.

Finally, there is no longer any need (or as much need) to have a vicinity-deployed “early warning system” which hopefully detects termites on their way to (before the termites reach) the structure, since this early warning is mostly necessitated during the months between human inspections. Instead, once the system's abilities have been verified or trained, detectors may be deployed in the structure to be protected, rather than in the structure's vicinity, given that detection is essentially immediate. This also improves detection e.g. if detectors are deployed in the vulnerable (e.g. attractive to termites and/or foundational hence costly and inconvenient to fix) portions of the residence, relative to conventional detection in which detectors are in baiting stations whose bait may or may not be discovered by the termites, who may prefer the vulnerable residence over the bait in the stations and/or may happen upon the vulnerable residence without passing through the bait stations. Typically, bait stations do not form a continuous ring around the residence to be protected, and are instead deployed at intervals from one another.

Another advantage is that the non-human-error-prone, essentially immediate, systematic detection provided by embodiments herein makes late-stage termite-infestation a rarity or extinct. It is appreciated that extreme measures, such as tenting (e.g. as described here: https://www. reynoldspest.com/blog/post/termite-fumigation-tenting-how-it-works-and-how-to-prepare-your-home) are not infrequently resorted to, today, due to late-stage infestations. In contrast, early detected infestation can be treated much more easily. Not only will termites in protected residences be detected earlier, due to the improved system herein, the percentage of residence-owners who will choose to avail themselves of the improved, efficient, low-cost convenient system herein is expected to be higher than the percentage of owners who are willing to commit to the costly, cumbersome, unsatisfactory termite detection systems that are used today. Since late-stage termite-infestation also (perhaps even primarily) occurs in buildings which are unprotected, this is an important advantage of embodiments herein.

Yet another advantage is in streamlining the real estate business; today, transactions are held up by termite inspections which, once the system herein is verified and/or trained, become superfluous, in buildings which are protected by the system herein.

Once use of the system herein becomes commonplace out of a desire to easily avoid infestation, particularly late-stage infestation, and/or due to a standard imposed by mortgage providers and lenders, more data will become available which will result in even further refinement of the system e.g., due to continued machine learning. It is appreciated that training data provided by human inspectors can include an indication of the termite species to enable separate algorithms to be operated for each of plural types of termites, thereby to enhance detection rates by precision-configuring a detection algorithm to each species, then running algorithms configured for all relevant species, on data collected by each individual sensor at each individual location in each individual residence to be protected.

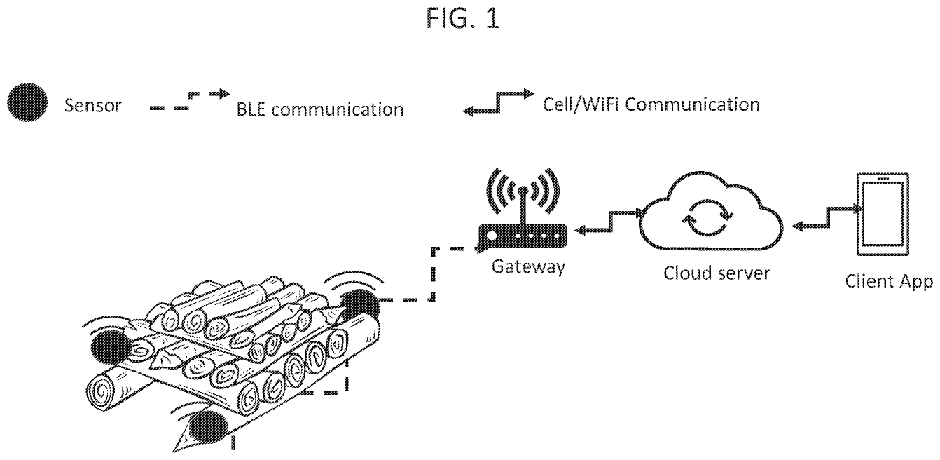

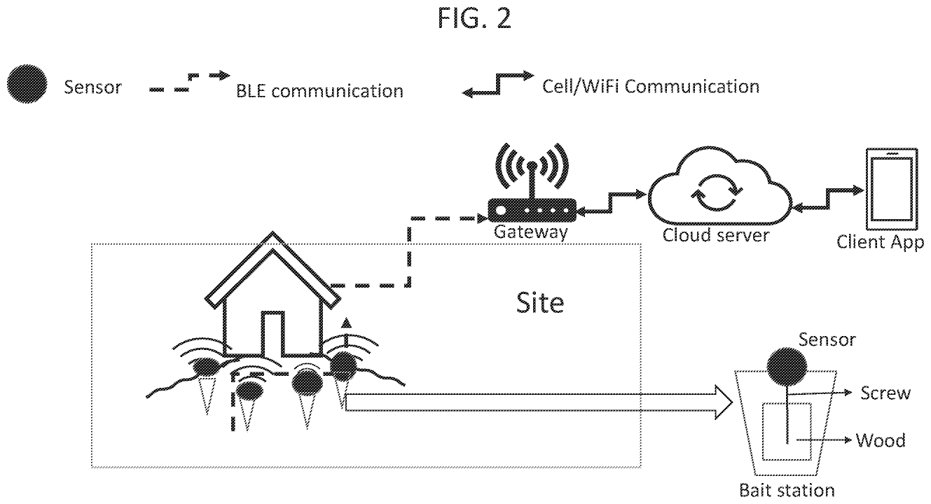

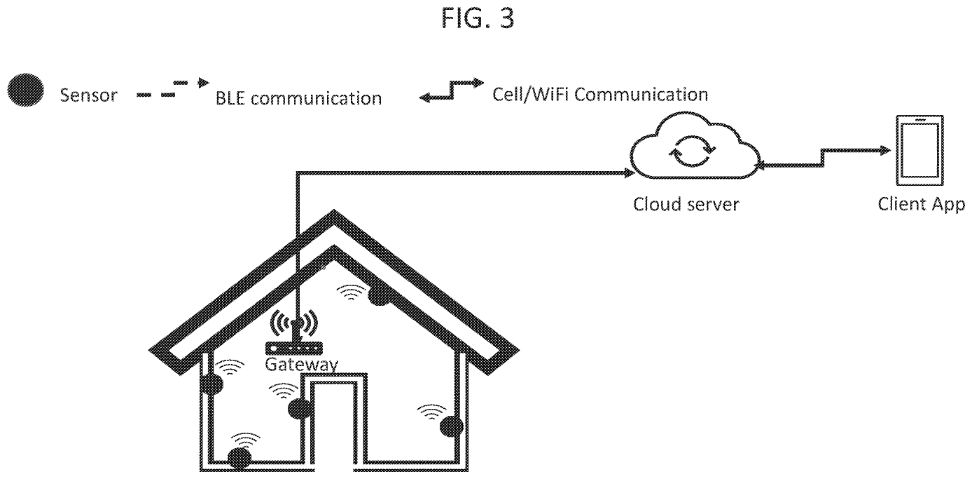

FIGS. 1-3 depict example systems, not necessarily to scale, for detection of burrowing insects in timbers, bait stations (of which, for simplicity, only one is shown), and homes, in accordance with embodiments of the invention. FIG. 8 depicts systems, not necessarily to scale, for detection of burrowing insects in trees.

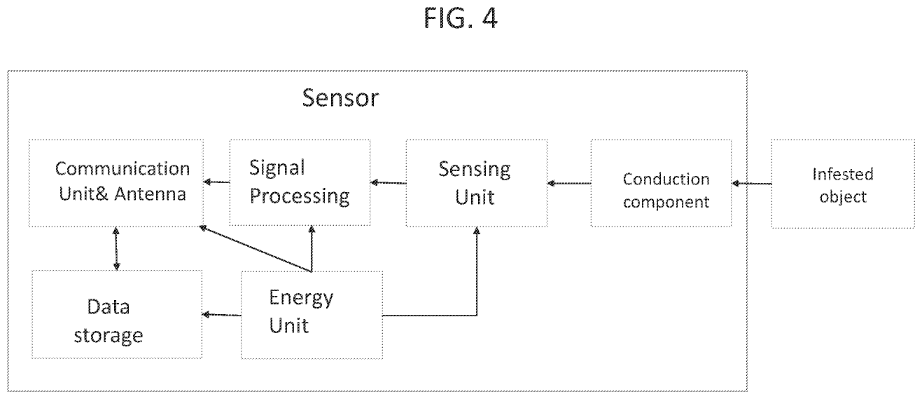

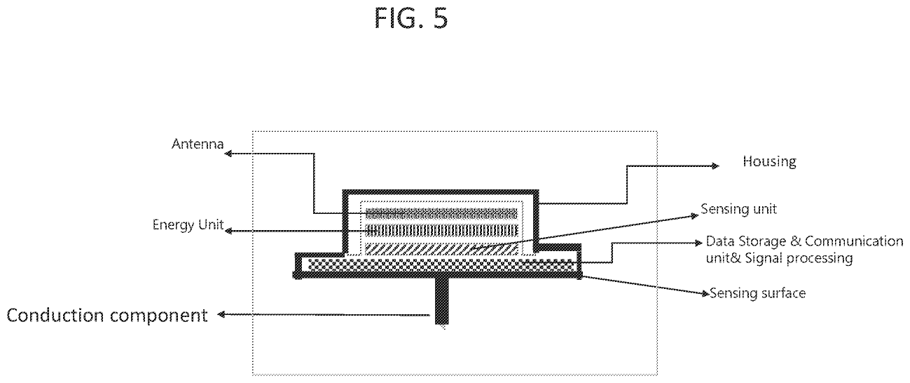

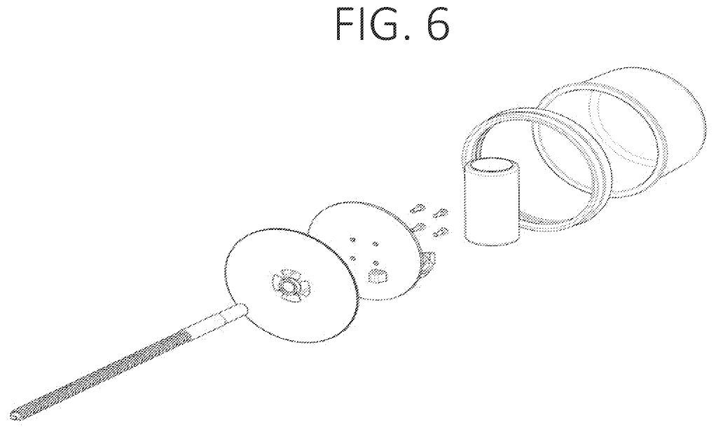

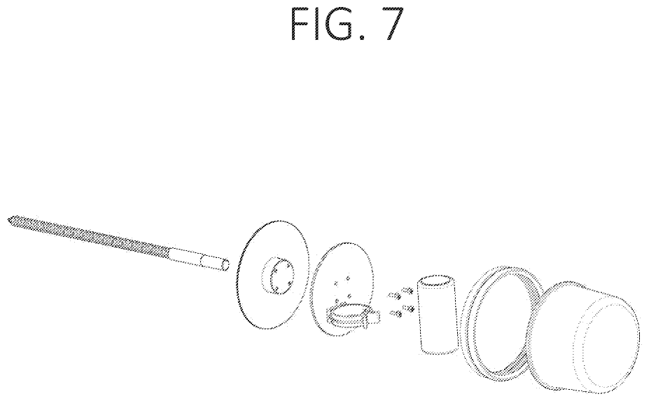

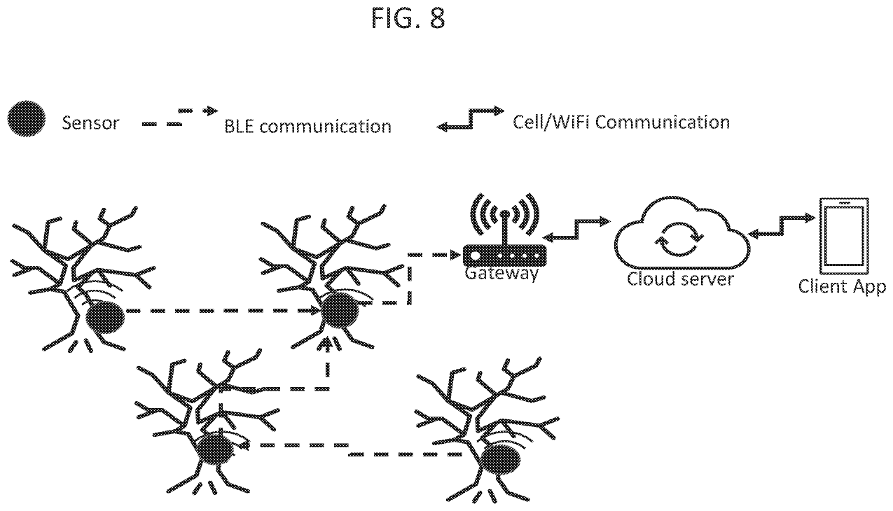

As shown, the systems of FIGS. 1-3, 8 may comprise sensors, e.g. as shown, schematically, in FIG. 4 or as shown, in cross-section, in FIG. 5 (which may be manufactured to scale) or may be based on any sensing technology known in the art, such as but not limited to the sensors described in co-owned patent document https://patents.google.com/patent/US11324210B2. Typically, each sensor includes at least a MEMS sensing unit (e.g., accelerometer or microphone), antenna, antenna communication, and signal processing (e.g., noise filtering) e.g. on a suitable PCB (printed circuit board). The sensor is typically configured to receive a signal which is indicative of presence of a burrowing insect as opposed to absence thereof and/or process the signal, typically locally and/or send the information to a central processor, typically via a gateway.

It is appreciated that all or any subset of the modules/components shown in FIGS. 4, 5 may be provided and may be interconnected in any suitable manner e.g., as shown. The conduction component, typically formed of metal, is typically configured to be driven or screwed into a substrate in which insect-generated vibrations are to be sensed e.g., wood. Thus, the sensor typically connects to the (typically wooden) object in which insect vibrations are being measured or sensed via a screw or stud which firmly engages the sensor with the wood. Any known sensing surface may be employed herein such as but not limited to a metal surface connected to the sensor (or sensing unit) and the conduction component, and serves to increase the contact area with the object (wall, furniture, etc.) being sampled, so that the vibration signal will be received, by the sensor, not only through the conduction component, but also through the sensing surface. Typically, the sensing surface is a mechanical, and not an electronical component. The Comm unit, aka communication unit, may include circuitry which provides any suitable typically wireless communication such as BLE communication, for transmitting information accumulated and/or processed and stored in the sensor to the gateway. The energy unit which distributes energy/power to the components of the sensor typically comprises a battery e.g., with associated cables, resistors, and voltage stabilizers. The sensing unit includes all electrical components responsible for converting vibration into an electrical signal, typically including an accelerometer and associated amplifiers. Data storage may store output (typically signal-processed) of sensing unit/s for a given window of time. This output may be batched; each batch may be sent up to the server and memory is then cleared for the next batch of sensing unit outputs. The sensor embodiments of FIGS. 4 and 5 may be used in-house, or, if desired, for trees e.g., as shown in FIG. 8 and/or for bait stations and/or for timbers, e.g., as shown in FIG. 1. Alternatively, any known sensor e.g., as described in the co-owned patent document mentioned herein, may be employed e.g., for trees.

Termite detection processing may occur on a central server which may be deployed e.g. on a cloud and may receive data from sites e.g. homes, directly from individual sensors or via gateways (e.g. controllers) which may be deployed on-site and which may communicate with all sensors deployed at a given site, on the one hand, and with the central server, on the other hand. Each gateway may be deployed at a suitable (typically single) location per residence or protected area. For example, the gateway, if battery operated, may be deployed anywhere in the grounds (e.g., garden) or even house/building if the garden is close to the house, to support communication between the stations and the gateway. Communication may be wireless e.g., communication between sensors and the gateway local to them may be wireless, such as but not limited to Bluetooth Low Energy aka BLE communication.

A human interface or web platform or application e.g., cell app, may be provided to present termite detection results to end-users and/or to system administrators; communication with the server (e.g. on the cloud) may for example be cellular or WiFi. Communication between the cloud server and gateway may also be cellular or WiFi, and includes all or any subset of: a threaded front prong which may be driven e.g. screwed into wood to be monitored for presence of termites, a base which may be aluminum cast, an electronic board e.g., PCB, which may be screwed to the base, a sealing rubber O-ring intermediate the base and the PCB, one or more batteries (or other power source e.g. solar panel or mains interface), a cover for the batteries which may be screwed to the base, and an O-ring under the cover (typically Nitrile rubber (NBR) or any other sealing elastomer. The cross section need not be circular as shown, and may instead be, for example an oblong e.g., square. The PCB may include a WiFi interface to the remote server.

Front end processing provided by the sensor may include all or any subset of the functionalities shown or described in co-owned patent document https://patents.google.com/patent/US11324210B2

e.g., sampling, pulse detection, dynamic termite detection threshold choice typically ML-powered, activity marking, and auxiliary sensors, such as but not limited to any of a temperature sensor, humidity sensor, accelerometer, which may be tri-axis, oxygen sensor, methane sensor, or microphone. Communication between a server application on the cloud, and the sensors in the field may be wireless, wired, or optical fiber.

Typically, the system shown herein will have an associated application e.g., cell app and WiFi to report from home to the cloud, and perform processing and analysis of the information remotely and centrally, and report to end-users from the cloud.

The length of the screw may for example be between 3-20 cm; an inventory may include plural e.g., 4 screw lengths, such 2 cm, 7 cm, 10 cm, and 20 cm lengths. An end-user can then use, for detection of termites in walls and furniture, a screw of length 2 cm, for detection of termites in basement wood, 8 cm, for detection of termites in bait stations 10 cm (since the depth of commercial bait stations is about 15 cm) and for detection of termites in trees either a 10 cm screw or a 20 cm screw, depending on the thickness or cross-sectional size of the trunk. The term “basement wood” is intended to include beams which support the house and are embedded in the ground on which the house is built. The length of the screw depends on the type and the thickness of the detection object; typically, longer screws are used for thicker objects, whereas shorter screws are used for thinner objects, e.g., the length of the screw is typically at least 30% of the thickness of the monitored surface.

It is appreciated that sensors' conduction components may be driven e.g., screwed into many household objects without interfering with their functions or normal use; if desired, the sensor may be as small and compact (and hence unobtrusive) as the batteries that the sensor houses. To prevent children from pulling the sensor out of its engagement with the household object, the sensor may be screwed or otherwise securely driven into household objects (or into a piece of wood which is in any case inside bait stations, and when the termites bite the wood, the system may discover these bites.

Any suitable deployment of the sensors in the building (say) to be protected may be employed. For example, since termites need moist areas to survive, sensors may be deployed along the roof and along the walls of the basement, bathrooms and kitchen, all say every 3 meters.

When termites engage in eating, foraging, or head-banging, the wood substrate where the termites are found has acoustic features which differ from a wood substrate in which no termites are found. This is one possible basis for development of a sensor for early detection of termites e.g., in trees and bait stations.

Developing a sensor for termite detection in trees and bait stations while ignoring environmental noises may be similar to the process for early detection of a Red Palm Weevil e.g. as described in the following co-owned patent document: https://patents.google.com/patent/US11324210B2 typically with focus on behaviour and characteristics of termites, specifically, either in general, or separately, per each species of termites. Developing a sensor for termite detection e.g., in trees and/or bait stations while mitigating environmental noises may include all or any subset of the following:

Sensor Design: Conduct research on termite behaviour, characteristics, and their typical habitats in trees and bait stations. Design a (typically seismic) sensor sensitive sufficient for detecting termite activity, while minimizing impact of or filtering out environmental noises.

Data collection: Build a prototype that records the seismic signals typically while using noise filtering techniques e.g., Kalman noise filtering, seismic noise filtering, or neural-network based noise reduction (e.g. based on a feedforward denoising neural network (e.g. DnCNN)). Use the prototype to record the termites' signals and environmental noises in controlled environments. Laboratory setups may be used that simulated field conditions, to evaluate its ability to detect termites, while ignoring environmental noises. Responsively, improvements to the algorithm may be made.

Data Analysis and Algorithm Development: Analyze the data collected and recorded to develop algorithms and models for termite detection while mitigating environmental noises. This involves signal processing techniques (e.g., for noise filtering) e.g. on a suitable PCB and machine learning algorithms (such as, by way of non-limiting example, Hidden Markov models or recurrent neural networks) to separate termite signals from environmental noises and other false positives.

Sensor Development: Build a prototype that incorporates the seismic sensing technology and the developed algorithm. Test the prototype in controlled environments—laboratory and field conditions, to evaluate its ability to detect termites while ignoring environmental noises. Responsively, improvements to the algorithm may be made.

Testing and Validation: Validate the prototype sensor in real-world field conditions, specifically focusing on its ability to ignore environmental noises and accurately detect termite activity in trees and bait stations. Evaluate its performance in different environmental conditions that may introduce noises, such as wind, rain, or other ambient sounds. Adjust noise filtering parameters or sensor settings responsively.

Cloud decision-making algorithm (AI): Based on the data analysis and algorithm development in the sensor, a cloud decision-making algorithm may be provided that optimizes and refines the data from the sensor, to improve the accuracy and reliability in detecting termites in trees and bait stations and different environments, while ignoring environmental noises. This may involve noise filtering techniques and AI algorithm parameters to enhance its performance in real-world conditions. The Artificial Intelligence algorithm will continue to improve the performance of the system as more information from the sensors is added to improve the accuracy and speed of early detection.

Field Testing and fine-tuning the algorithms: Test the optimized sensor in real-world field conditions, including trees and/or bait stations where termites are known to be active, to validate its performance in detecting termites, while effectively mitigating environmental noises. Gather data and feedback from field testing to further refine the sensor and algorithms, as needed.

According to certain embodiments, the algorithm is configured or trained to detect termites biting a (typically wooden) substrate or bait and not, or not only, head-banging of soldier termites who may call out when a nest e.g., in a tree, is in danger. It is appreciated that seismic data may be tagged or labelled, during R & D, e.g. by classifying the termite activity (e.g. as burrowing, biting, or head-banging) and/or termite characteristics (e.g. termite species, number of termites, termite role (e.g. soldier/worker/king/queen), relying on human experts examining imagery of the termites captured (in field and/or lab conditions) while the seismic data was collected and/or relying on image processing of this imagery.

According to certain embodiments, sensor readings from N1 trees infected with termites of type (e.g., species) 1, and from N2 trees infected with termites of type (e.g., species) 2, and from N3 trees infected with termites of type 3, and from M trees which are NOT infected, are collected. Y may be a binary variable (infestation yes/no) or may be a probability of infestation, or may be a multi-level variable (e.g., infestation very likely, somewhat likely, unlikely, almost definitely clean). X variables may be identified which characterize the sensor readings e.g., various features of the sensor readings (e.g., presence of peaks including at least one of peak height, width, prevalence) which may be characteristic of infested wood and are rare in non-infested wood. Regression analysis (or ANOVA or multivariate analysis) may be used to find a linear analytic function of the X variables, which best predicts the Y variable/s. This may be used as the initial termite detection algorithm, which may then be improved by machine learning. Clustering may be employed to computationally differentiate n species of termites, and only then each species may be separately determined to be present/absent.

Alternatively, or in addition, termite image recognition suitable for mobile applications has been suggested e.g., here: https://academic.oup.com/jee/article/114/6/2452/6359981.

Termite detection may also be based on known principles such as sound amplification or microwave detection as by TERM_A_TRAC™.

Or, for example, a support vector classification (SVc) and artificial neural network (ANN) algorithm were reported to have been “applied to recognize the termites' signals. After optimizing various input types, kernel functions and model parameters, a robust model was successfully constructed with a specific capability, i.e., a SVc model for detecting termites and ANN model for estimating the termite population”.
https://www.researchgate.net/publication/334982512_Development_of_termite_detection_system _based_on_acoustic_and_temperature_signals

Machine learning may be used to leverage knowledge which naturally accumulates about termite detection outcomes, as sites (e.g., bait stations deployed at the sites) are manually inspected by humans worldwide.

According to certain embodiments, sensor deployment variables (e.g., where deployed and/or how closely spaced) are defined and systematically tested to enable the system to use its learning ability in order to determine optimal deployments (e.g., deployments which detected early infestations numbering only a few termites, as opposed to deployments which detected late infestations numbering a larger number of termites). Typically, the system records the deployment variables for each residence, and also records the number of termites found by the human inspector or any other variable/s indicative of how early the infestation was detected e.g., cost of repairs if known, which would be lower for earlier detected infestations than for later detected infestations.

According to certain embodiments, human involvement characteristics are defined and systematically tested to enable the system to use its learning ability in order to determine optimal human involvement (e.g., desired frequency of human inspection, or desired rapidity of dispatchment of exterminators once termites have been discovered). Typically, the system records the human involvement characteristics for each residence and also records variable/s indicative of successful treatment e.g., % infested buildings per year, and/or variable/s indicative of how early infestations were detected.

According to certain embodiments, if T types of termites are known to be a threat, the system s/w runs plural e.g., T tests to detect all T types of termites, since the test for detecting type 1 (e.g., first species) termites may be inoperative, or non-optimal, for detecting type 2 (e.g., another species) termites. Typically, the end-user receives output indicative of an alert on the presence of termites, not on which kind of termites. However, inspectors may provide data to the system, regarding the species of termite.

The termite detection algorithm may be developed for and/or trained on each type of pest separately. Sensors may record the raw data of a pest of a given type e.g., species, and the data is then analyzed (e.g., by noise filtering) to find the signal and develop a detection algorithm accordingly, which is typically burned into the sensor. Subsequently, these sensors may begin to sample infected and clean trees and, based on this, AI in the cloud may direct decision-making regarding the condition of the tree.

A particular advantage of certain embodiments is that most of the billions spent on termite (e.g.) control are spent on human technicians visiting premises every (say) 3 months, where most visits are, in retrospect, superfluous, since no termites are found, thus no pest control is required. According to embodiments herein, the human inspection occurs only in that fraction of cases in which termites are automatically found by a system active continuously ( 24/7).

It is appreciated that termites even affect the real estate business; reportedly, many lenders to would-be home purchasers refuse to make a loan without a termite clearance letter. This and periodic inspection may be obviated, as the system improves, by leveraging the vast existing array of bait stations being inspected periodically.

Another advantage of embodiments herein is that the sensors may detect termites living inside furniture or firewood, which are both sources of infestation. The system herein may include a compact sensor to stick into furniture or firewood, enabling furniture or firewood to be sold as “termite-safe”.

According to certain embodiments, deployment of bait stations is reduced or eliminated e.g., once the system is demonstrated to be well trained, in comparison to human evaluations of existing deployments of bait stations. Thus, once the system herein, which is based on sensors conveniently driven into a target to be protected, such as a structure e.g., home, or household objects, or industrial or agricultural wood, is known to be operative, it may no longer be necessary to deploy bait stations in the ground surrounding the target. This is advantageous because bait stations in the ground are ecologically damaging, since burrowing insects which have not yet attacked any target are also destroyed, even though they are biologically beneficial to the ecosphere. Bait stations in the ground are also costly to deploy, inspect, and maintain.

It is appreciated that embodiments herein are merely exemplary and are not intended to be limiting. For example, all references to termites herein may more generally relate to burrowing insects. References herein to protection of “buildings” from termites are intended to refer as well to any other target substrates or substrates to be protected e.g. wood repositories, and repositories of fabrics e.g. (e.g. for the textile industry). “Gardens” are intended to refer to any type of grounds in which a substrate to be protected may be located. Vibrations may optionally be sensed in a substrate e.g., in the ground or in wood, by using an optical fiber for conveying the vibrations. The sensor need not necessarily detect vibration; instead, visual detection, say, may be employed. For example, leaf caterpillars are not borers, and may be detected visually, which may include capturing video or still sensor output and using image processing, perhaps remotely, to detect certain insects.

Also, according to certain embodiments, sensors are deployed in bait stations (or furniture, pre-fabricated walls, etc.) a priori e.g. the conductive components are screwed into the wood bait in the factory. Alternatively, or in addition, sensors herein may be deployed in the field, in already-deployed bait stations, or in homes, trees, timber etc. e.g., by screwing or otherwise driving the sensor's conductive component into bait, furniture, walls, trees, etc., in the field.

Moreover, poison may be deployed initially e.g., in the factory or when deploying bait stations, or only upon discovery of infestation. Typically, when a human inspector deploys poison into a bait station, s/he may also deploy the system of the present invention e.g., by putting into the bait station a new piece of wood bait into which a seismic sensor, e.g., as described herein, may be driven. According to some embodiments, bait stations are deployed initially without poison, and only upon discovery of infestation, is poison added to the stations.

It is appreciated that terminology such as “mandatory”, “required”, “need” and “must” refer to implementation choices made within the context of a particular implementation or application described herein for clarity, and are not intended to be limiting, since, in an alternative implementation, the same elements might be defined as not mandatory and not required, or might even be eliminated altogether.

Components described herein as software may, alternatively, be implemented wholly or partly in hardware and/or firmware, if desired, using conventional techniques, and vice-versa. Each module or component or processor may be centralized in a single physical location or physical device, or distributed over several physical locations or physical devices.

Included in the scope of the present disclosure, inter alia, are electromagnetic signals in accordance with the description herein. These may carry computer-readable instructions for performing any or all of the operations of any of the methods shown and described herein, in any suitable order, including simultaneous performance of suitable groups of operations, as appropriate. Included in the scope of the present disclosure, inter alia, are machine-readable instructions for performing any or all of the operations of any of the methods shown and described herein, in any suitable order; program storage devices readable by machine, tangibly embodying a program of instructions executable by the machine to perform any or all of the operations of any of the methods shown and described herein, in any suitable order i.e. not necessarily as shown, including performing various operations in parallel or concurrently, rather than sequentially, as shown; a computer program product comprising a computer useable medium having computer readable program code, such as executable code, having embodied therein, and/or including computer readable program code for performing, any or all of the operations of any of the methods shown and described herein, in any suitable order; any technical effects brought about by any or all of the operations of any of the methods shown and described herein, when performed in any suitable order; any suitable apparatus or device or combination of such, programmed to perform, alone or in combination, any or all of the operations of any of the methods shown and described herein, in any suitable order; electronic devices each including at least one processor and/or cooperating input device and/or output device and operative to perform, e.g., in software, any operations shown and described herein; information storage devices or physical records, such as disks or hard drives, causing at least one computer or other device to be configured so as to carry out any or all of the operations of any of the methods shown and described herein, in any suitable order; at least one program pre-stored, e.g., in memory, or on an information network such as the Internet, before or after being downloaded, which embodies any or all of the operations of any of the methods shown and described herein, in any suitable order, and the method of uploading or downloading such, and a system including server/s and/or client/s for using such; at least one processor configured to perform any combination of the described operations or to execute any combination of the described modules; and hardware which performs any or all of the operations of any of the methods shown and described herein, in any suitable order, either alone or in conjunction with software. Any computer-readable or machine-readable media described herein is intended to include non-transitory computer- or machine-readable media.

Any computations or other forms of analysis described herein may be performed by a suitable computerized method. Any operation or functionality described herein may be wholly or partially computer-implemented e.g., by one or more processors. The invention shown and described herein may include (a) using a computerized method to identify a solution to any of the problems or for any of the objectives described herein, the solution optionally including at least one of a decision, an action, a product, a service, or any other information described herein, that impacts, in a positive manner, a problem or objectives described herein; and (b) outputting the solution.

The system may, if desired, be implemented as a network, e.g., web-based system, employing software, computers, routers, and telecommunications equipment, as appropriate.

Any suitable deployment may be employed to provide functionalities e.g., software functionalities shown and described herein. For example, a server may store certain applications, for download to clients, which are executed at the client side, the server side serving only as a storehouse. Any or all functionalities e.g., software functionalities shown and described herein, may be deployed in a cloud environment. Clients e.g., mobile communication devices such as smartphones, may be operatively associated with, but external to the cloud.

The scope of the present invention is not limited to structures and functions specifically described herein, and is also intended to include devices which have the capacity to yield a structure, or perform a function, described herein, such that even though users of the device may not use the capacity, they are, if they so desire, able to modify the device to obtain the structure or function.

Any “if-then” logic described herein is intended to include embodiments in which a processor is programmed to repeatedly determine whether condition x, which is sometimes true and sometimes false, is currently true or false, and to perform y each time x is determined to be true, thereby to yield a processor which performs y at least once, typically on an “if and only if” basis e.g., triggered only by determinations that x is true, and never by determinations that x is false.

Any determination of a state or condition described herein, and/or other data generated herein, may be harnessed for any suitable technical effect. For example, the determination may be transmitted or fed to any suitable hardware, firmware or software module, which is known or which is described herein, to have capabilities to perform a technical operation responsive to the state or condition. The technical operation may, for example, comprise changing the state or condition, or may more generally cause any outcome which is technically advantageous given the state or condition or data, and/or may prevent at least one outcome which is disadvantageous given the state or condition or data. Alternatively, or in addition, an alert may be provided to an appropriate human operator or to an appropriate external system.

Features of the present invention, including operations, which are described in the context of separate embodiments, may also be provided in combination in a single embodiment. For example, a system embodiment is intended to include a corresponding process embodiment, and vice versa. Also, each system embodiment is intended to include a server-centered “view” or client centered “view”, or “view” from any other node of the system, of the entire functionality of the system, computer-readable medium, apparatus, including only those functionalities performed at that server or client or node. Features may also be combined with features known in the art, and particularly although not limited to, those described in the Background section or in publications mentioned therein.

Conversely, features of the invention, including operations, which are described for brevity in the context of a single embodiment or in a certain order, may be provided separately, or in any suitable sub-combination, including with features known in the art (particularly although not limited to those described in the Background section or in publications mentioned therein) or in a different order. “e.g.” is used herein in the sense of a specific example which is not intended to be limiting. Each method may comprise all or any subset of the operations illustrated or described, suitably ordered e.g., as illustrated or described herein.

Devices, apparatus or systems shown coupled in any of the drawings may, in fact, be integrated into a single platform in certain embodiments, or may be coupled via any appropriate wired or wireless coupling, such as but not limited to optical fiber, Ethernet, Wireless LAN, HomePNA, power line communication, cell phone, Smart Phone (e.g. iPhone), Tablet, Laptop, PDA, Blackberry GPRS, Satellite including GPS, or other mobile delivery. It is appreciated that in the description and drawings shown and described herein, functionalities described or illustrated as systems and sub-units thereof can also be provided as methods and operations therewithin, and functionalities described or illustrated as methods and operations therewithin can also be provided as systems and sub-units thereof. The scale used to illustrate various elements in the drawings is merely exemplary and/or appropriate for clarity of presentation, and is not intended to be limiting.

Any suitable communication may be employed between separate units herein e.g. wired data communication and/or in short-range radio communication with sensors such as cameras, e.g., via Wifi, Bluetooth, or Zigbee.

It is appreciated that implementation via a cellular app as described herein is but an example, and, instead, embodiments of the present invention may be implemented, say, as a smartphone SDK, as a hardware component, as an STK application, or as suitable combinations of any of the above.

Any processing functionality illustrated (or described herein) may be executed by any device having a processor, such as but not limited to a mobile telephone, set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network, or is tethered directly or indirectly/ultimately to such a node).

Any operation or characteristic described herein may be performed by another actor outside the scope of the patent application, and the description is intended to include apparatus, whether hardware, firmware or software which is configured to perform, enable, or facilitate that operation or to enable, facilitate, or provide that characteristic.

The terms processor or controller or module or logic, as used herein, are intended to include hardware such as computer microprocessors or hardware processors, which, typically, have digital memory and processing capacity, such as those available from, say Intel and Advanced Micro Devices (AMD). Any operation or functionality or computation or logic described herein may be implemented entirely or in any part on any suitable circuitry, including any such computer microprocessor/s, as well as in firmware or in hardware, or any combination thereof.

It is appreciated that elements illustrated in more than one drawings, and/or elements in the written description may still be combined into a single embodiment, except if otherwise specifically clarified herein. Any of the systems shown and described herein may be used to implement or may be combined with, any of the operations or methods shown and described herein.

It is appreciated that any features, properties, logic, modules, blocks, operations or functionalities described herein, which are, for clarity, described in the context of separate embodiments, may also be provided in combination in a single embodiment, except where the specification or general knowledge specifically indicates that certain teachings are mutually contradictory, and cannot be combined. Any of the systems shown and described herein may be used to implement or may be combined with, any of the operations or methods shown and described herein.

Conversely, any modules, blocks, operations or functionalities described herein, which are, for brevity, described in the context of a single embodiment, may also be provided separately or in any suitable sub-combination, including with features known in the art. Each element e.g., operation described herein, may have all characteristics and attributes described or illustrated herein, or, according to other embodiments, may have any subset of the characteristics or attributes described herein.

It is appreciated that apps or applications referred to herein may include a cell app, mobile app, computer app, or any other application software. Any application may be bundled with a computer and its system software or published separately. The term “phone” and similar used herein is not intended to be limiting and may be replaced or augmented by any device having a processor, such as but not limited to a mobile telephone, or also set-top-box, TV, remote desktop computer, game console, tablet, mobile e.g. laptop or other computer terminal, embedded remote unit, which may either be networked itself (may itself be a node in a conventional communication network e.g.) or may be conventionally tethered to a networked device (to a device which is a node in a conventional communication network or is tethered directly or indirectly/ultimately to such a node). Thus, the computing device may even be disconnected from e.g., WiFi, Bluetooth, etc. but may be tethered directly or ultimately to a networked device.

References herein to “said (or the) element x” having certain (e.g., functional or relational) limitations/characteristics, are not intended to imply that a single instance of element x is necessarily characterized by all the limitations/characteristics. Instead, “said (or the) element x” having certain (e.g. functional or relational) limitations/characteristics is intended to include both (a) an embodiment in which a single instance of element x is characterized by all of the limitations/characteristics and (b) embodiments in which plural instances of element x are provided, and each of the limitations/characteristics is satisfied by at least one instance of element x, but no single instance of element x satisfies all limitations/characteristics. For example, each time L limitations/characteristics are ascribed to “said” or “the” element X in the specification or claims (e.g. to “said processor” or “the processor”), this is intended to include an embodiment in which L instances of element X are provided, which respectively satisfy the L limitations/characteristics, each of the L instances of element X satisfying an individual one of the L limitations/characteristics. The plural instances of element x need not be identical. For example, if element x is a hardware processor, there may be different instances of x, each programmed for different functions and/or having different hardware configurations (e.g., there may be 3 instances of x: two Intel processors of different models, and one AMD processor).

1. A system for controlling burrowing insects, the system comprising:
a remote server configured to communicate with plural sets of seismic sensors respectively deployed at plural premises, each set at a given premises including seismic sensor/s deployed at respective location/s within the given premises;
wherein each seismic sensor enables vibrations of an insect-consumable substance, into which the seismic sensor is driven, to be sensed, thereby to yield sensor output data, and
a communication unit which communicates, from the sensor to the remote server, all or any subset of:
i. the sensor output data,
ii. an identifier unique to the individual seismic sensor; and
iii. a time-stamp identifying a point in time at which the sensor output data was sensed by the seismic sensor, thereby to define time-stamp/s;
and wherein the remote server is configured to differentiate, for at least one point in time, an insect-consumable substance in which burrowing insects are present from an insect-consumable substance in which no burrowing insects are present, and to store information associating identifiers of certain seismic sensors, with data indicating whether burrowing insects are present in the insect-consumable substance into which each of said certain seismic sensors are respectively driven, at given stored points in time corresponding to the time-stamp/s.

2. The system according to claim 1 wherein the seismic sensors comprise baiting stations which include bait, enabling insects to burrow in or consume the bait, and wherein the insect-consumable substance comprises said bait.

3. The system according to claim 1 and also comprising baiting stations which include bait accessible to insects, enabling insects to burrow in or consume the bait, and wherein the seismic sensors comprise the baiting stations and the insect-consumable substance comprises said bait.

4. The system according to claim 1 and also comprising seismic sensors configured to be driven into a household object which functions as the insect-consumable substance.

5. The system according to claim 1 wherein the seismic sensors are configured to be driven into a household object which functions as the insect-consumable substance.

6. A method for controlling burrowing insects, the method comprising:
providing a remote server configured to communicate with plural sets of seismic sensors respectively deployed at plural premises, each set at a given premises including seismic sensor/s deployed at respective location/s within the given premises,
wherein seismic sensors enable vibrations of an insect-consumable substance, into which the seismic sensor is driven, to be sensed, thereby to yield sensor output data, and
providing a communication unit which communicates, from the sensor to the remote server, all or any subset of:
i. the sensor output data,
ii. an identifier unique to the individual seismic sensor; and
iii. a time-stamp identifying a point in time at which the sensor output data was sensed by the seismic sensor, thereby to define time-stamp/s;
and wherein the remote server includes at least one hardware processor configured to differentiate, for at least one point in time, an insect-consumable substance in which burrowing insects are present from an insect-consumable substance in which no burrowing insects are present, and to store information associating identifiers of certain seismic sensors, with data indicating whether burrowing insects are present in the insect-consumable substance into which each of said certain seismic sensors are respectively driven, at given stored points in time corresponding to the time-stamp/s.

7. The method of claim 6 wherein the plural sets of seismic sensors are respectively deployed within plural sets of bait stations respectively deployed at the plural premises, and wherein the server is trained to differentiate substances in which burrowing insects are present from substances in which burrowing insects are absent, using outcomes of human inspections of the plural sets of bait stations as tags, which, when coupled with outputs from seismic sensors, serve as training data, thereby to yield a detection algorithm for at least one species of burrowing insect.

8. The method of claim 7 wherein the outcomes of human inspections include indications of which species of burrowing insect were present and wherein the server is trained to differentiate substances in which burrowing insects of a first species are present from substances in which burrowing insects of the first species are absent using outcomes of human inspections of the plural sets of bait stations, which indicate whether the first species was present or absent, as tags, thereby to yield a first detection algorithm for the first species of burrowing insect.

9. The method of claim 8 wherein the server is also trained to differentiate substances in which burrowing insects of a second species are present from substances in which burrowing insects of the second species are absent using outcomes of human inspections of the plural sets of bait stations, which indicate whether the second species was present or absent, as tags, thereby to yield a second detection algorithm for the second species of burrowing insect.

10. The method of claim 7 wherein the detection algorithm is applied to sensor data collected by seismic sensors deployed indoors thereby to provide improved indoor detection by leveraging human inspections of bait stations deployed outdoors.

11. The method of claim 9 wherein the first and second detection algorithms are each applied to sensor data collected by seismic sensors deployed indoors to provide improved indoor detection of insects belonging to the first and second species by using separately optimized algorithms for various species, rather than a single general insect presence detection algorithm, by leveraging species-specific human inspections of bait stations deployed outdoors.

12. The system according to claim 1 and wherein the communication unit communicates, from the sensor to the remote server, all of:
i. the sensor output data,
ii. the identifier unique to the individual seismic sensor; and
iii. the time-stamp identifying the point in time at which the sensor output data was sensed.

13. The system according to claim 1 wherein the insect-consumable substance comprises a termite-consumable substance such as wood, and wherein the remote server is configured to differentiate, for at least one point in time, a termite-consumable substance in which termites are present from a termite-consumable substance in which no termites are present, and to store information associating identifiers of certain seismic sensors, with data indicating whether termites are present in the termite-consumable substance into which each of said certain seismic sensors' respective seismic sensors are respectively driven, at given stored points in time corresponding to the time-stamp/s.

14. A computer program product, comprising a non-transitory tangible computer readable medium having computer readable program code embodied therein, said computer readable program code adapted to be executed to implement a method for controlling burrowing insects, the method comprising:
providing a remote server configured to communicate with plural sets of seismic sensors respectively deployed at plural premises, each set at a given premises including seismic sensor/s deployed at respective location/s within the given premises,
wherein seismic sensors enable vibrations of an insect-consumable substance, into which the seismic sensor is driven, to be sensed, thereby to yield sensor output data, and
providing a communication unit which communicates, from the sensor to the remote server, all or any subset of:
i. the sensor output data,
ii. an identifier unique to the individual seismic sensor; and
iii. a time-stamp identifying a point in time at which the sensor output data was sensed by the seismic sensor, thereby to define time-stamp/s;
and wherein the remote server includes at least one hardware processor configured to differentiate, for at least one point in time, an insect-consumable substance in which burrowing insects are present from an insect-consumable substance in which no burrowing insects are present, and to store information associating identifiers of certain seismic sensors, with data indicating whether burrowing insects are present in the insect-consumable substance into which each of said certain seismic sensors are respectively driven, at given stored points in time corresponding to the time-stamp/s.
